(19) United States
(12) Patent Application Publication
(10) Pub. No.: US 2026/0141686 A1
(43) Pub. Date: May 21, 2026

(54) APPARATUS AND METHOD FOR CURATING OBJECT RECOGNITION DATA IN A LIGHTWEIGHT NETWORK SYSTEM

(71) Applicants: Hyundai Motor Company, Seoul (KR); Kia Corporation, Seoul (KR)

(72) Inventor: Sunkyung Kim, Hwaseong-si (KR)

(21) Appl. No.: 19/202,889

(22) Filed: May 8, 2025

(30) Foreign Application Priority Data
Nov. 15, 2024 (KR) 10-2024-0162653

(51) Int. Cl. G06V 10/771; G06V 10/74; G06V 10/77; G06V 20/70

(52) U.S. Cl. CPC G06V 10/771; G06V 10/761; G06V 10/7715; G06V 20/70

(57) ABSTRACT

A method for curating object recognition data in a lightweight network system includes labeling each of a plurality of image data collected from the system, collecting labeling information, collecting the feature data with respect to each of the plurality of image data based on the labeling information, and curating some image data among the plurality of image data based on the collected feature data, where the collecting the feature data with respect to each of the plurality of image data based on the labeling information may include marking and cropping at least one object portion in each of the plurality of image data by a bounding box based on the labeling information, extracting local feature data including local feature information with respect to the object portion from the cropped image data, dimensionally reducing the extracted local feature data, and collecting the dimensionally reduced local feature data as the feature data.

### CROSS-REFERENCE TO RELATED APPLICATIONS

This application claims priority to and the benefit of Korean Patent Application No. 10-2024-0162653 filed in the Korean Intellectual Property Office on Nov. 15, 2024, the entire contents of which is incorporated herein by reference.

### TECHNICAL FIELD

The present disclosure relates to an apparatus and method for curating object recognition data in a lightweight network system. More particularly, the present disclosure relates to an apparatus and method for curating object recognition data in a lightweight network system for efficient learning of an edge-end lightweight network and improvement of algorithm performance.

### BACKGROUND

Recently, robot deployment sites and the number of robots are expected to increase due to the commercialization of robots, such as robot-friendly buildings. There is a need to develop an algorithm that efficiently curates various field data obtained from multiple robots.

A model installed in an edge-end robot does not continue to improve simply by learning from a lot of data. In the case of learning by using the entire data, it takes a long time for the model to learn and the performance is not always good.

For such a purpose, it is extremely important to curate appropriate data with diverse distributions so that the model can learn well. That is, when data is curated, performance similar to or better than that obtained by learning using full data may be obtained.

### SUMMARY

The present disclosure attempts to provide an apparatus and method for curating object recognition data in a lightweight network system capable of curating images with various features through feature-based sampling to improve the performance of object recognition in a system (e.g., a robot system) requiring a lightweight network.

The present disclosure attempts to provide an apparatus and method for curating object recognition data in a lightweight network system capable of collecting feature information of each image based on labeling information obtained from the image, and curating images with a low similarity based on feature information in each image, to train a model.

A method for curating object recognition data in a lightweight network system may include labeling each of a plurality of image data collected from the system and collecting labeling information, collecting the feature data with respect to each of the plurality of image data based on the labeling information, and curating some image data among the plurality of image data based on the collected feature data, where the collecting the feature data with respect to each of the plurality of image data based on the labeling information may include marking and cropping at least one object portion in each of the plurality of image data by a bounding box based on the labeling information, extracting local feature data including local feature information with respect to the object portion from the cropped image data, dimensionally reducing the extracted local feature data, and collecting the dimensionally reduced local feature data as the feature data.

The collecting the dimensionally reduced local feature data as the feature data may include generating the feature data by concatenating the plurality of dimensionally reduced local feature data when the dimensionally reduced local feature data is provided in a plural quantity.

The extracting local feature data including the local feature information with respect to the object portion from the cropped image data may include inputting the cropped image data into a vision transformer (ViT) to output the local feature data.

The dimensionally reducing the extracted local feature data may include dimensionally reducing the local feature data by using a principal component analysis (PCA) technique.

The collecting the feature data with respect to each of the plurality of image data based on the labeling information may further include inputting each of the plurality of image data into the vision transformer (ViT) to output global feature data, and collecting the output global feature data as the feature data.

The curating some image data among the plurality of image data based on the collected feature data may include randomly selecting first image data from among the plurality of image data, measuring cosine similarity between the first image data and other image data, and curating second image data having smallest cosine similarity with the first image data as one of that some image data.

The randomly selecting first image data from among the plurality of image data may include randomly selecting first local feature data from among a plurality of local feature data extracted from the first image data.

The measuring cosine similarity between the first image data and other image data may include measuring cosine similarity between the local feature data respectively extracted from the other image data and the first local feature data.

The measuring cosine similarity between the first image data and other image data may include measuring cosine similarity between first global feature data extracted from the first image data and the global feature data respectively extracted from the other image data.

A method for curating object recognition data in a lightweight network system may further include repeatedly performing the curating some image data among the plurality of image data based on the collected feature data until the quantity of the curated some image data reaches a predetermined threshold quantity.

An apparatus for curating object recognition data in a lightweight network system by executing a program code loaded on one or more memory devices through one or more processors, the program code is configured, when executed, to perform: collecting labeling information by labeling each of a plurality of image data collected from the lightweight network system, collecting the feature data with respect to each of the plurality of image data based on the labeling information, curating some image data among the plurality of image data based on the collected feature data, where the collecting the feature data with respect to each of the plurality of image data based on the labeling information may include marking and cropping at least one object portion in each of the plurality of image data by a bounding box based on the labeling information, extracting local feature data including local feature information with respect to the object portion from the cropped image data, dimensionally reducing the extracted local feature data, and collecting the dimensionally reduced local feature data as the feature data.

The collecting the dimensionally reduced local feature data as the feature data may include generating the feature data by concatenating the plurality of dimensionally reduced local feature data when the dimensionally reduced local feature data is provided in a plural quantity.

The extracting the local feature data including the local feature information with respect to the object portion from the cropped image data may include inputting the cropped image data into a vision transformer (ViT) to output the local feature data.

The dimensionally reducing the extracted local feature data may include dimensionally reducing the local feature data by using a principal component analysis (PCA) technique.

The collecting the feature data with respect to each of the plurality of image data based on the labeling information may further include inputting each of the plurality of image data into the vision transformer (ViT) to output global feature data, and collecting the output global feature data as the feature data.

The curating some image data among the plurality of image data based on the collected feature data may include randomly selecting first image data from among the plurality of image data, measuring cosine similarity between the first image data and other image data, curating second image data having smallest cosine similarity with the first image data as one of that some image data.

The randomly selecting first image data from among the plurality of image data may include randomly selecting first local feature data from among a plurality of local feature data extracted from the first image data.

The measuring cosine similarity between the first image data and other image data may include measuring cosine similarity between the local feature data respectively extracted from the other image data and the first local feature data.

The measuring cosine similarity between the first image data and other image data may include measuring cosine similarity between first global feature data extracted from the first image data and the global feature data respectively extracted from the other image data.

The apparatus for curating object recognition data may further include repeatedly performing the curating some image data among the plurality of image data based on the collected feature data until the quantity of the curated some image data reaches a predetermined threshold quantity.

An apparatus and method for curating object recognition data in a lightweight network system according to an embodiment the same or better performance, by collecting feature information of each image based on labeling information obtained from the image, and curating images with a low similarity based on feature information in each image, to train a model.

### BRIEF DESCRIPTION OF THE DRAWINGS

FIG. 1 shows a flowchart for curating object recognition data in a lightweight network system according to an embodiment.

FIG. 2 is a block diagram of an apparatus for curating object recognition data in a lightweight network system according to an embodiment.

FIG. 3 is a flowchart of the image data curation step of FIG. 1 according to an embodiment.

FIG. 4, FIG. 5, and FIG. 6 are flowcharts for a method for curating object recognition data in a lightweight network system according to an embodiment.

FIG. 7 is a drawing for explaining a feature extracting algorithm according to an embodiment.

FIG. 8 is a drawing for explaining an image data curation step according to an embodiment.

FIG. 9 is a drawing for explaining an effect of an apparatus and method for curating object recognition data in a lightweight network system according to an embodiment.

FIG. 10 is a drawing for explaining a computing device according to an embodiment.

### DETAILED DESCRIPTION OF ILLUSTRATIVE EMBODIMENTS

An embodiment of the disclosure will be described more fully hereinafter with reference to the accompanying drawings such that a person skill in the art may easily implement the embodiment. As those skilled in the art would realize, the described embodiments may be modified in various different ways, all without departing from the spirit or scope of the present disclosure. In order to clarify the present disclosure, parts that are not related to the description will be omitted, and the same elements or equivalents are referred to with the same reference numerals throughout the specification.

In addition, unless explicitly described to the contrary, the word “comprise” and variations such as “comprises” or “comprising” will be understood to imply the inclusion of stated elements but not the exclusion of any other elements. Terms including an ordinary number, such as first and second, are used for describing various constituent elements, but the constituent elements are not limited by the terms. The terms are only used to differentiate one component from other components.

In addition, the terms “unit”, “part” or “portion”, “-er”, and “module” in the specification refer to a unit that processes at least one function or operation, which may be implemented by hardware, software, or a combination of hardware and software. In addition, at least a partial configuration or function of an apparatus and method for curating object recognition data in a lightweight network system according to embodiments described below may be implemented as a program or software, and the program or software may be stored in a computer-readable medium.

Hereinafter, embodiments of the present disclosure will be described with reference to the drawings.

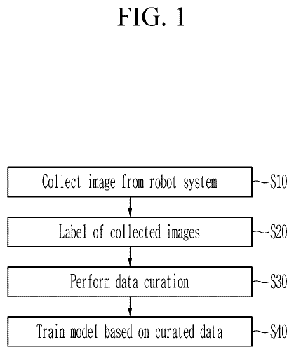

FIG. 1 shows a flowchart of a method for curating object recognition data according to an embodiment.

A system for curating the object recognition data in the lightweight network system proposes a method with respect to how to curate data in order to improve performance of object recognition in a system (e.g., a robot system) requiring a lightweight network.

In FIG. 1, at step S10, the system for curating the object recognition data may collect an image from the robot system.

The image may be an image collected from a robot or images corresponding to one frame of the image.

At step S20, the system for curating the object recognition data may perform labeling with respect to the collected image.

In an embodiment, the labeling may be performed by an external labeling company, and the system for curating the object recognition data may collect the labeling results.

At step S30, the system for curating the object recognition data may perform data curation based on the labeled data.

The system for curating the object recognition data may curate a partial data among the labeled data through data curation according to an apparatus and method for curating the object recognition data.

For example, the method for curating object recognition data proposed in the present disclosure may be sampling images having various features.

That is, the object recognition data curation apparatus may perform the method for curating object recognition data in which images with various features are finally curated based on the features.

At step S40, the system for curating the object recognition data may train a model based on the curated data.

The data curated according to the method for curating object recognition data according to an embodiment may be used in a learning model (e.g., a convolutional neural network (CNN)). For example, YOLOX may be used as the learning model.

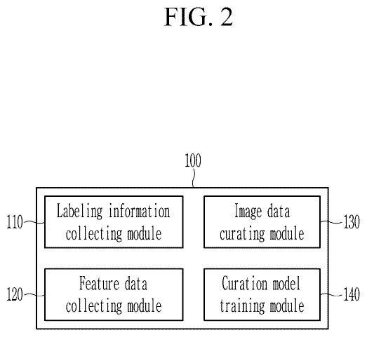

FIG. 2 is a block diagram of an apparatus for curating the object recognition data in the lightweight network system according to an embodiment.

An apparatus 100 for curating the object recognition data in the lightweight network system (hereinafter, also referred to as the object recognition data curation apparatus) according to an embodiment may execute a program code or instruction stored in one or more memory device(s) using one or more processor(s).

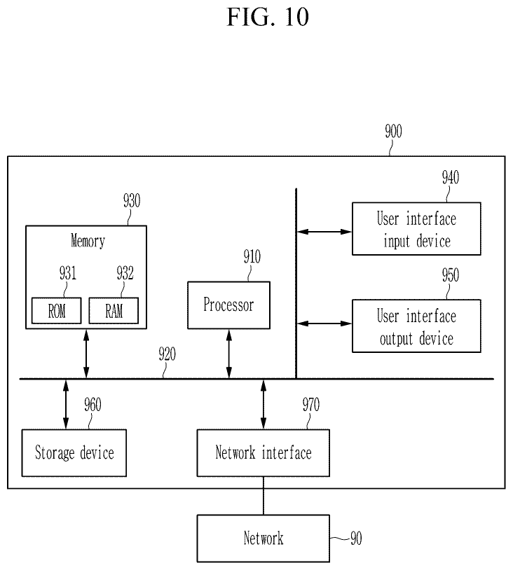

For example, the apparatus 100 for curating object recognition data may be implemented as a computing device 900 described later with reference to FIG. 10. In this case, one or more processor(s) may correspond to a processor 910 of the computing device 900, and one or more memory device(s) may correspond to a memory 930 of the computing device 900.

The program code or instruction may be executed by one or more processor(s), to curate the object recognition data having various features in the lightweight network system.

In this disclosure, the term “module” is used to logically differentiate functions performed by the program code or instruction.

Referring to FIG. 2, the apparatus 100 for curating object recognition data may include a labeling information collecting module 110, a feature data collecting module 120, an image data curating module 130, and a curation model training module 140.

The labeling information collecting module 110 may collect labeling information obtained by labeling each of a plurality of image data collected from the lightweight network system.

The feature data collecting module 120 may collect the feature data with respect to each of the plurality of image data based on the labeling information.

The feature data collecting module 120 may mark and crop at least one object portion in each of the plurality of image data by a bounding box based on the labeling information.

The feature data collecting module 120 may extract the local feature data including local feature information with respect to the object portion from the cropped image data.

For example, the feature data collecting module 120 may input the cropped image data into a vision transformer (ViT) to output the local feature data.

The vision transformer is a new deep learning model for image recognition that uses a unique method to divide images into small patches for processing. Each patch is input into a natural language processing model called a transformer, which learns the relationships between patches and performs classification tasks. Through this, higher accuracy and efficiency than conventional CNNs may be achieved.

The feature data collecting module 120 may dimensionally reduce the extracted local feature data.

The feature data collecting module 120 may dimensionally reduce the local feature data by using a principal component analysis (PCA) technique.

The principal component analysis (PCA) is a method for dimensionally reducing multi-dimensional data, which is a statistical technique to extract major principal components that can best explain the data.

The purpose of the PCA is to reduce the dimensionality while maximally preserving the variance of data. To do this, PCA projects the data by creating new variables called principal components. The principal components have the same dimensions as the original data and are adjusted so that they are uncorrelated with each other.

A first principal component is set in the direction that explains the most variance of the original data, and subsequent principal components are set in the direction that explains the remaining variance.

The PCA may be used to reduce the dimensionality of data, remove noise, and maintain key information.

In an embodiment, the feature data collecting module 120 may input each of the plurality of image data into the vision transformer (ViT) to output the global feature data, and may collect the outputted global feature data as the feature data.

That is, the feature data collecting module 120 may finally collect the local feature data and the global feature data as the feature data with respect to each image, respectively.

The feature data collecting module 120 may collect the dimensionally reduced local feature data as the feature data.

When the dimensionally reduced local feature data is provided in a plural quantity, the feature data collecting module 120 may generate the feature data by concatenating a plurality of dimensionally reduced local feature data.

In addition, the feature data collecting module 120 may collect the dimensionally reduced global feature data as the feature data.

The image data curating module 130 may curate some image data among the plurality of image data based on the collected feature data.

The image data curating module 130 may measure similarity with respect to the plurality of image data based on the feature data, and may curate only some image data having low similarities among the plurality of image data based on the measured similarity.

The image data curating module 130 may randomly select a first image data from among the plurality of image data.

For example, the image data curating module 130 may randomly select first local feature data from among a plurality of local feature data extracted from the first image data.

The image data curating module 130 may measure cosine similarity between the first image data and other image data.

The cosine similarity is one method for measuring the similarity between vectors, and calculates the similarity by using an angle between two vectors. The cosine similarity may have a value from −1 to 1, where two vectors may be determined to be similar when the value is closer to 1, and, and two vectors may be determined to be different when the value is closer to −1.

The image data curating module 130 may measure cosine similarity between the local feature data respectively extracted from other image data and the first local feature data.

In addition, the image data curating module 130 may measure cosine similarity between first global feature data extracted from the first image data and the global feature data respectively extracted from other image data.

The image data curating module 130 may curate a second image data having smallest cosine similarity with the first image data as one of the curated image data.

Until the quantity of the curated image data reaches a predetermined threshold quantity, the image data curating module 130 may repeatedly perform the process of curating the image data among the plurality of image data based on the collected feature data.

The curation model training module 140 may train an artificial intelligence model with the curated image data.

For example, the artificial intelligence model may include a CNN learning model, and may be a YOLOX model as one of object detection models.

The curated image data may include image data curated from among the entire image data received from the robot system and having various distributions.

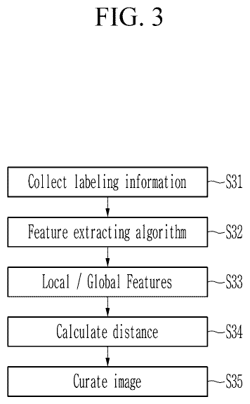

FIG. 3 is a flowchart of the image data curation step S30 of FIG. 1 according to an embodiment. The process of curating image data may be performed through the apparatus 100 for curating object recognition data.

In FIG. 3, at step S31, the apparatus 100 for curating object recognition data may collect labeling information with respect to the plurality of image data.

At step S32, the apparatus 100 for curating object recognition data may extract the feature data with respect to the image data labeled based on the collected labeling information.

At step S33, the apparatus 100 for curating object recognition data may extract a local image feature (in short, local feature) and a global image feature (in short, global feature) as the feature data through the feature extracting algorithm (step S32).

At step S34, the apparatus 100 for curating object recognition data may measure distances between image data based on the cosine similarity calculated with respect to each of image data based on the local image feature and the global image feature.

At step S35, the apparatus 100 for curating object recognition data may perform image curation that curates some images among a plurality of entire images based on the measured distance.

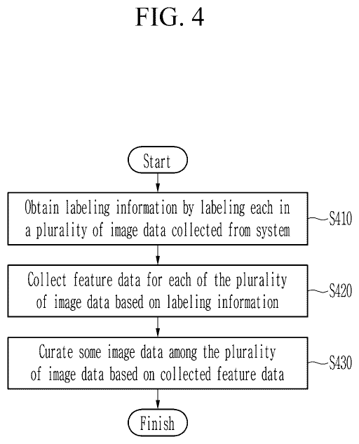

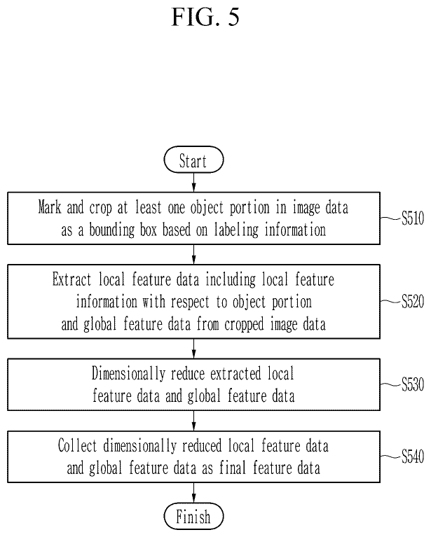

FIG. 4 to FIG. 6 are flowcharts for a method for curating the object recognition data in the lightweight network system according to an embodiment.

FIG. 4 to FIG. 6 are drawings for detailed description with respect to the feature extracting algorithm (step S32, see FIG. 3) and the image curation process (step S35, see FIG. 3) according to the flowchart of FIG. 3. The method for curating object recognition data shown in FIG. 4 to FIG. 6 may be performed through the apparatus 100 for curating object recognition data (see FIG. 2).

FIG. 4 is a flowchart of the method for curating object recognition data according to an embodiment.

In FIG. 4, at step S410, the apparatus 100 for curating object recognition data may label each of the plurality of image data collected from the lightweight network system, and collect the labeling information.

At step S420, the apparatus 100 for curating object recognition data may collect the feature data with respect to each of the plurality of image data based on the labeling information.

When the dimensionally reduced local feature data is provided in a plural quantity, by concatenating the plurality of dimensionally reduced local feature data with respect to one image data, the apparatus 100 for curating object recognition data may generate the feature data with respect to that image.

At step S430, the apparatus 100 for curating object recognition data may curate only some image data among the plurality of image data based on the collected feature data.

FIG. 5 is a flowchart with respect to a feature extracting algorithm according to an embodiment. FIG. 5 is a flowchart showing details of the feature data collection of the step 420 of FIG. 4.

In FIG. 5, at step S510, the apparatus 100 for curating object recognition data may mark and crop at least one object portion in each of the plurality of image data by a bounding box based on the labeling information.

At step S520, the apparatus 100 for curating object recognition data may extract the local feature data including the local feature information with respect to the object portion and the global feature data from the cropped image data.

The apparatus 100 for curating object recognition data may input the cropped image data into the vision transformer (ViT) to output the local feature data.

Alternatively, the apparatus 100 for curating object recognition data may input the image data before the cropping into the vision transformer (ViT) and to output the global feature data.

At step S530, the apparatus 100 for curating object recognition data may dimensionally reduce the extracted local feature data and the global feature data.

The apparatus 100 for curating object recognition data may dimensionally reduce the local feature data or the global feature data by using the principal component analysis (PCA) technique.

At step S540, the apparatus 100 for curating object recognition data may collect the dimensionally reduced local feature data and the global feature data as final feature data.

FIG. 6 is a flowchart with respect to an image curation algorithm according to an embodiment. FIG. 6 is a flowchart showing details of the data curation step of the step 430 of FIG. 4.

In FIG. 6, at step S610, the apparatus 100 for curating object recognition data may randomly select the first image data from among the plurality of image data.

The apparatus 100 for curating object recognition data may randomly select the first local feature data from among the plurality of local feature data extracted from the first image data.

At step S620, the apparatus 100 for curating object recognition data may measure cosine similarity between the first image data and other image data.

The apparatus 100 for curating object recognition data may measure cosine similarity between the local feature data respectively extracted from other image data and the first local feature data.

Alternatively, the apparatus 100 for curating object recognition data may measure cosine similarity between the first global feature data extracted from the first image data and the global feature data respectively extracted from other image data.

At step S630, the apparatus 100 for curating object recognition data may curate the second image data having smallest cosine similarity with the first image data as one of that some image data.

At step S640, the apparatus 100 for curating object recognition data may repeatedly perform the curating of that some image data among the plurality of image data (step S610 to step S630) until the quantity of the curated some image data reaches the predetermined threshold quantity.

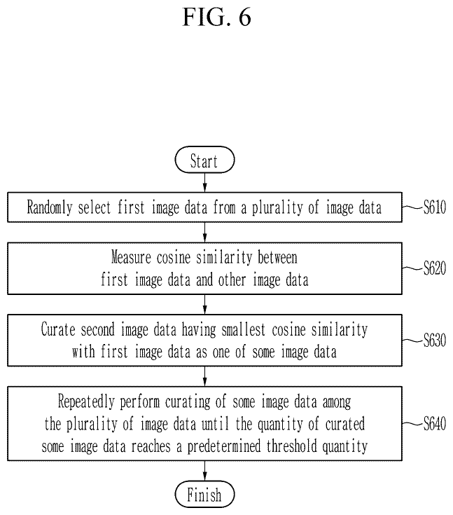

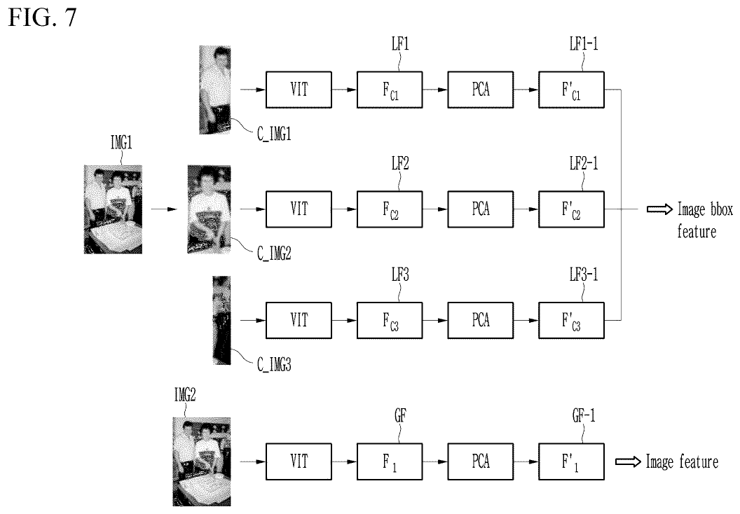

FIG. 7 is a drawing for explaining a feature extracting algorithm according to an embodiment.

FIG. 7 shows a first embodiment image IMG1 and a second embodiment image IMG2. FIG. 7 shows an embodiment of collecting the feature data from the image data through the first embodiment image IMG1 and the second embodiment image IMG2.

The first embodiment image IMG1 and the second embodiment image IMG2 may be any images of the plurality of image data collected from the robot system, and may be the same or different images.

In FIG. 7, the apparatus 100 for curating object recognition data may extract the plurality of local feature data from the first embodiment image IMG1, and by combining the extracted local feature data, may collect the feature data with respect to that image.

In more detail, the apparatus 100 for curating object recognition data may crop the object position of the first embodiment image IMG1 by using the bounding box, to generate a plurality of cropped images C_IMG1, C_IMG2, and C_IMG3.

The apparatus 100 for curating object recognition data may input the generated cropped images C_IMG1, C_IMG2, and C_IMG3 into ViT, to extract each of the local feature LF1, LF2, and LF3.

The apparatus 100 for curating object recognition data may dimensionally reduce the local feature LF1, LF2, and LF3 through the PCA, and may collect the dimensionally reduced local features LF1-1, LF2-1, and LF3-1.

The apparatus 100 for curating object recognition data may finally collect the feature data with respect to that image IMG1 by concatenating the collected dimensionally-reduced local features LF1-1, LF2-1, and LF3-1.

The apparatus 100 for curating object recognition data may extract the global feature data from the second embodiment image IMG2, and may collect the feature data with respect to that image from the extracted global feature data.

In more detail, the apparatus 100 for curating object recognition data may extract a global feature GF by entirely inputting the second embodiment image IMG2 into the ViT.

The apparatus 100 for curating object recognition data may dimensionally reduce the global feature GF through the PCA, and may collect the dimensionally reduced global feature GF-1.

The apparatus 100 for curating object recognition data may collect the dimensionally reduced global feature GF-1 as the feature data with respect to that image IMG2.

By utilizing at least one of the local feature or global feature with respect to one image, the apparatus 100 for curating object recognition data may collect the feature data with respect to that image.

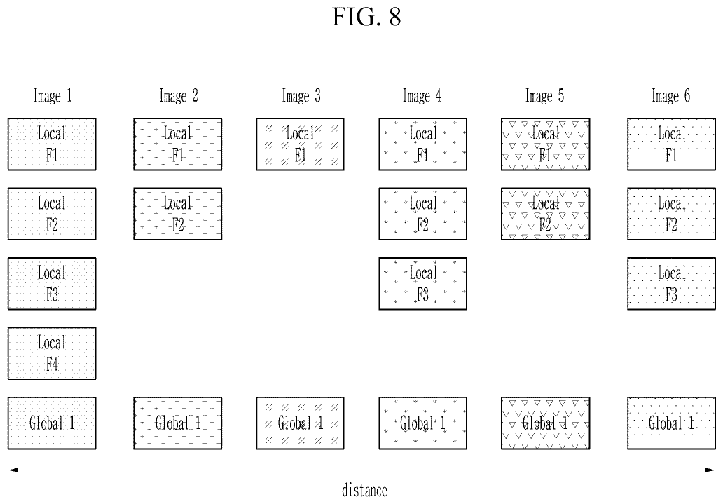

FIG. 8 is a drawing for explaining the image data curation step according to an embodiment.

In FIG. 8, the apparatus 100 for curating object recognition data may calculate a distance between the plurality of image data (e.g., Image 1 to Image 6) to curate some data.

The distance may be inversely proportional to the cosine similarity. That is, when the cosine similarity is small, the distance is large.

The apparatus 100 for curating object recognition data may collect each of the local feature data and the global feature data as the feature data with respect to a plurality of image data Image 1 to Image 6.

The apparatus 100 for curating object recognition data may select the first local feature data (e.g., local F1) and the first global feature data (e.g., Global 1) with respect to one image data (one of Image 1 to Image 6) randomly selected from among the plurality of image data Image 1 to Image 6.

For example, the apparatus 100 for curating object recognition data may randomly select a first image data Image 1 from among the plurality of image data Image 1 to Image 6.

The apparatus 100 for curating object recognition data may randomly select the first local feature data (e.g., local F1) and the first global feature data (e.g., Global 1) with respect to the first image data Image 1.

The apparatus 100 for curating object recognition data may randomly select the local feature data and the global feature data with respect to each of remaining image data (e.g., Image 2 to Image 6) excluding the first image data Image 1.

The apparatus 100 for curating object recognition data may measure cosine similarity between the first local feature data (e.g., local F1) and the first global feature data (e.g., Global 1) and the local feature data and the global feature data randomly selected from each of the remaining image data.

The apparatus 100 for curating object recognition data may finally curate one image data (e.g., Image 6) having a smallest cosine similarity with the first image data Image 1 based on the local feature data and the global feature data.

That is, the apparatus 100 for curating object recognition data may store a sixth image data (Image 6) having a lowest cosine similarity with and a farthest distance from the first image data Image 1 as the curation data.

For example, the apparatus 100 for curating object recognition data may primarily select the plurality of image data having the smallest cosine similarity between data of a plurality of images based on the local feature data, and then among them, may finally curate at least one pair of image data having the smallest cosine similarity based on the global feature data.

For example, the apparatus 100 for curating object recognition data may finally curate at least one pair of image data having a smallest sum of the cosine similarity value based on the local feature data and the cosine similarity value based on the global feature data between the plurality of image data.

Until the image data as many as the predetermined quantity are curated between the plurality of image data, the apparatus 100 for curating object recognition data may repeatedly perform the curation process.

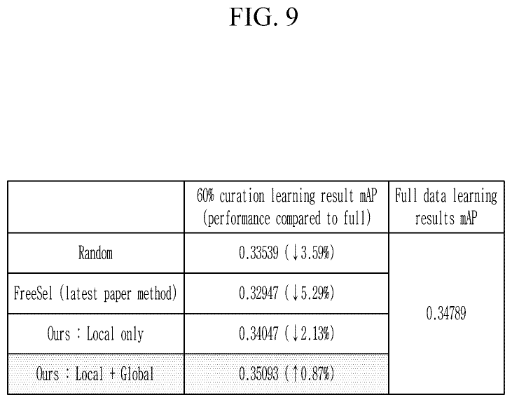

FIG. 9 is a drawing for explaining an effect of an apparatus and method for curating the object recognition data in the lightweight network system according to an embodiment.

In FIG. 9, in the learning results in the case that the entire dataset was used as in the conventional art and in the case that the object data curation is performed by reducing data to approximately 60%, the performance is comparatively evaluated between the random, the latest model, and the method for curating object recognition data of the present disclosure.

When the local feature data and the global feature data are utilized according to the method for curating object recognition data of the present disclosure, the learning result (mAP) was 0.35093, and it may be seen that the performance has been improved by 0.87% compared to the learning result of entire data of 0.34789.

FIG. 10 is a diagram for describing a computing device according to an exemplary embodiment of present disclosure.

Referring to FIG. 10, an apparatus and method for curating the object recognition data in the lightweight network system according to an embodiment may be implemented by using the computing device 900.

The computing device 900 may include at least one of a processor 910, a memory 930, the user interface input device 940, the user interface output device 950 and a storage device 960 that communicate through a bus 920. The computing device 900 may also include a network interface 970 electrically connected to a network 90. The network interface 970 may transmit or receive signals with other entities through the network 90.

The processor 910 may be implemented in various types such as a micro controller unit (MCU), an application processor (AP), a central processing unit (CPU), a graphic processing unit (GPU), a neural processing unit (NPU), and the like, and may be any type of semiconductor device capable of executing instructions stored in the memory 930 or the storage device 960. The processor 910 may be configured to implement the functions and methods described above with reference to FIGS. 1 to 9.

The memory 930 and the storage device 960 may include various types of volatile or non-volatile storage media. For example, the memory may include read-only memory (ROM) 931 and a random-access memory (RAM) 932. In this embodiment, the memory 930 may be located inside or outside processor 910, and the memory 930 may be connected to the processor 910 through various known means.

In some embodiments, at least some components or functions of an apparatus and method for curating object recognition data in a lightweight network system according to the embodiments may be implemented as programs or software executed by the computing device 900, and the programs or software may be stored in a computer-readable medium.

In some exemplary embodiments, at least some components or functions of an apparatus and method for curating object recognition data in a lightweight network system according to the exemplary embodiments may be implemented using hardware or circuit of the computing device 900 or may be implemented as separate hardware or circuit that may be electrically connected to the computing device 900.

While this disclosure has been described in connection with what is presently considered to be practical embodiments, it is to be understood that the disclosure is not limited to the disclosed embodiments, but, on the contrary, is intended to cover various modifications and equivalent arrangements included within the spirit and scope of the appended claims.

### DESCRIPTION OF SYMBOLS

100: apparatus for curating the object recognition data in the lightweight network system
110: labeling information collecting module
120: feature data collecting module
130: image data curating module
140: curation model training module

What is claimed is:

1. A method for curating object recognition data in a lightweight network system, the method comprising:
labeling each of a plurality of image data collected from the lightweight network system to obtain labeling information;
collecting the labeling information;
collecting feature data with respect to each of the plurality of image data based on the labeling information; and
curating a portion of image data among the plurality of image data based on the collected feature data,
wherein the collecting the feature data with respect to each of the plurality of image data based on the labeling information comprises:
marking and cropping at least one object portion in each of the plurality of image data by a bounding box based on the labeling information;
extracting local feature data comprising local feature information with respect to the object portion from the cropped image data;
dimensionally reducing the extracted local feature data; and
collecting the dimensionally reduced local feature data as the feature data.

2. The method of claim 1, wherein collecting the dimensionally reduced local feature data as the feature data comprises:
generating the feature data by concatenating the plurality of dimensionally reduced local feature data when the dimensionally reduced local feature data is provided in a plural quantity.

3. The method of claim 1, wherein extracting local feature data comprising the local feature information with respect to the object portion from the cropped image data comprises:
inputting the cropped image data into a vision transformer (ViT) to output the local feature data.

4. The method of claim 1, wherein dimensionally reducing the extracted local feature data comprises:
dimensionally reducing the local feature data by using a principal component analysis (PCA) technique.

5. The method of claim 3, wherein collecting the feature data with respect to each of the plurality of image data based on the labeling information further comprises:
inputting each of the plurality of image data into the vision transformer (ViT) to output global feature data, and collecting the output global feature data as the feature data.

6. The method of claim 5, wherein curating the portion of image data among the plurality of image data based on the collected feature data comprises:
randomly selecting first image data from among the plurality of image data;
measuring cosine similarity between the first image data and other image data; and
curating second image data having smallest cosine similarity with the first image data as part of the portion of image data.

7. The method of claim 6, wherein randomly selecting first image data from among the plurality of image data comprises:
randomly selecting first local feature data from among a plurality of local feature data extracted from the first image data.

8. The method of claim 7, wherein measuring the cosine similarity between the first image data and the other image data comprises:
measuring the cosine similarity between the local feature data respectively extracted from the other image data and the first local feature data.

9. The method of claim 6, wherein measuring the cosine similarity between the first image data and the other image data comprises:
measuring the cosine similarity between first global feature data extracted from the first image data and the global feature data respectively extracted from the other image data.

10. The method of claim 6, further comprising:
repeatedly performing the curating the portion of image data among the plurality of image data based on the collected feature data until the quantity of the curated portion of image data reaches a predetermined threshold quantity.

11. An apparatus for curating object recognition data in a lightweight network system, the apparatus comprising:
one or more processors; and
one or more memory devices storing program code which, when executed by the one or more processors, cause the one or more processors to:
collect labeling information by labeling each of a plurality of image data collected from the lightweight network system;
collect the feature data with respect to each of the plurality of image data based on the labeling information;
curate a portion of image data among the plurality of image data based on the collected feature data,
wherein, to collect the feature data with respect to each of the plurality of image data based on the labeling information, execution of the program code further causes the one or more processors to:
mark and crop at least one object portion in each of the plurality of image data by a bounding box based on the labeling information;
extract local feature data comprising local feature information with respect to the object portion from the cropped image data;
dimensionally reduce the extracted local feature data; and
collect the dimensionally reduced local feature data as the feature data.

12. The apparatus of claim 11, wherein, to collect the dimensionally reduced local feature data as the feature data, execution of the program code further causes the one or more processors to:
generate the feature data by concatenating the plurality of dimensionally reduced local feature data when the dimensionally reduced local feature data is provided in a plural quantity.

13. The apparatus of claim 11, wherein, to extract the local feature data comprising the local feature information with respect to the object portion from the cropped image data, execution of the program code further causes the one or more processors to:
input the cropped image data into a vision transformer (ViT) to output the local feature data.

14. The apparatus of claim 11, wherein, to dimensionally reduce the extracted local feature data, execution of the program code further causes the one or more processors to:
dimensionally reduce the local feature data by using a principal component analysis (PCA) technique.

15. The apparatus of claim 13, wherein, to collect the feature data with respect to each of the plurality of image data based on the labeling information, execution of the program code further causes the one or more processors to:
input each of the plurality of image data into the vision transformer (ViT) to output global feature data; and
collect the output global feature data as the feature data.

16. The apparatus of claim 15, wherein, to curate the portion of image data among the plurality of image data based on the collected feature data, execution of the program code further causes the one or more processors to:
randomly select first image data from among the plurality of image data;
measure cosine similarity between the first image data and other image data;
curate second image data having smallest cosine similarity with the first image data as one of that some image data.

17. The apparatus of claim 16, wherein, to randomly select the first image data from among the plurality of image data, execution of the program code further causes the one or more processors to:
randomly select the first local feature data from among a plurality of local feature data extracted from the first image data.

18. The apparatus of claim 17, wherein, to measure the cosine similarity between the first image data and other image data, execution of the program code further causes the one or more processors to:
measure the cosine similarity between the local feature data respectively extracted from the other image data and the first local feature data.

19. The apparatus of claim 16, wherein, to measure the cosine similarity between the first image data and other image data, execution of the program code further causes the one or more processors to:
measure the cosine similarity between first global feature data extracted from the first image data and the global feature data respectively extracted from the other image data.

20. A non-transitory computer-readable medium storing programming for execution by one or more processors, the programming comprising instructions to:
label each of a plurality of images collected from a lightweight network system to obtain labeling information;
collect the labeling information;
collect feature data from each of the plurality of images based on the labeling information; and
curate a portion of images among the plurality of images based on the collected feature data,
wherein, to collect the feature data from each of the plurality of images based on the labeling information, the programming comprises further instructions to:
mark and crop at least one object portion in each of the plurality of images by a bounding box based on the labeling information;
extract local feature data from the at least one object portion;
dimensionally reduce the extracted local feature data; and
collect the dimensionally reduced local feature data as the feature data.
